(19) United States
(12) Patent Application Publication
(10) Pub. No.: US 2015/0095157 A1
(43) Pub. Date: Apr. 2, 2015

(54) METHODS AND SYSTEMS FOR DEFINING TARGETED GEOGRAPHIC ZONES FOR DELIVERING ELECTRONIC CONTENT

(71) Applicant: MapQuest, Inc., Denver, CO (US)

(72) Inventor: Patrick McDEVITT, Hanover, NH (US)

(73) Assignee: MapQuest, Inc., Denver, CO (US)

(21) Appl. No.: 14/041,971

(22) Filed: Sep. 30, 2013

(51) Int. Cl. G06Q 30/02

(52) U.S. Cl. CPC G06Q 30/0261
USPC 705/14.58

(57) ABSTRACT

Systems and methods are disclosed for online distribution of content. The method may include, receiving a request to publish content on the electronic device relating to a target location. The request may include at least one threshold travel parameter to the target location. The method also may include identifying one or more perimeter locations at the at least one threshold travel parameter and generating a zone extending from the one or more locations to the target location and including one or more routes. In addition, the method may include receiving an indication that the electronic device has entered the zone, transmitting content to the user's electronic device relating to the target location.

### TECHNICAL FIELD

Various embodiments of the present disclosure relate generally to providing online content based on geographical mapping information. More specifically, exemplary embodiments of the present disclosure relate to systems and methods for providing targeted electronic content based on the geographic location of a user.

### BACKGROUND

Recently, the use of electronic maps has become widespread through the use of in-vehicle or portable GPS devices, mobile devices, and other electronic devices. These electronic maps often convey information about roads, traffic, buildings, landmarks, terrain, etc., related to geographical regions of interest. Some electronic maps may be interactive, allowing users, for example, to view their current location on a map of a particular area and the surrounding areas. Many providers of electronic mapping services allow users to input origin and destination locations and provide various routing directions to and from the locations. The routing directions may be generated based on one or more of travel time, travel distance, traffic, construction, and time-of-day. Electronic map providers may determine and update routing information based on a user's location using GPS or other location detecting means transmitted by a user's electronic device. Based on this location information, the electronic maps may provide users with real-time information, such as live traffic information and dynamic routing adjustments.

At the same time, online content providers, such as advertisers and content publishers, have been sending targeted content to user's electronic devices based on the physical location of the user by analyzing the IP address and other user information (e.g., search history, cookies, etc.) transmitted or retrievable from a user's electronic device. For example, many online advertisers and publishers deliver electronic content (such as ads and multimedia) to users' devices based on IP address-based inferences of each user's general location, i.e., which city or country they are predicted to be in. However, such methods are very coarse, in that they do not target content based on information more granular than the major metropolitan area where the user is located. Such methods are also susceptible to location misdirection based on user tools such as virtual environments or desktops, and IP address detection blocking. Finally, such methods also do not take into account the movement, predicted location, and ability of the user to easily execute on the content and visit a particular location of interest. As a result, other methods for geographically targeted ads and content have been developed based on more granular levels of targeting. For example, businesses may “push” ads and/or content to users' devices when the user enters and connects to a Wi-Fi and/or Bluetooth network operated by the business. However, such methods are quite limited by the relatively short reach of the wireless network employed. Such methods are unable to reach a sufficiently large local audience that is within the reasonable area for making a decision to patronize the business.

Accordingly, a need exists for methods and systems for providing targeted electronic content related to a physical location of interest to an electronic map user, based on the current location of the user's device.

### SUMMARY

According to certain embodiments, systems and methods are disclosed for executing an online distribution of content to mobile device users. The method may include, receiving, from a content provider, a request to publish content on the electronic device of a user, the content relating to a target location and the request includes at least one threshold travel parameter to the target location. The method also may include identifying a perimeter location on a route. The travel perimeter location may be at the at least one threshold travel parameter. The method also may include generating a zone extending from the perimeter location to the target location. In addition, the method may include receiving an indication that the electronic device has entered the zone, and transmitting content to the electronic device of the user, the content relating to the target location.

The disclosed embodiments may include one or more of the following steps and/or features: the threshold travel parameter may be travel time, the travel time may be between about 2 to about 7 minutes, the travel time is based on current average traffic speed, the zone may include a plurality of zones, each of the plurality of zones may have shape corresponding to the shape of one of the one or more routes, the plurality of zones may have a width corresponding to the width of a lane of one of the one or more routes in a direction toward the target location, the zone may have a width corresponding to the width of a lane of one of the one or more routes in a direction toward the target location, the method may further include receiving other user information, the content may be an advertisement for the target location, the zone may exclude routes with traffic travelling in a direction away from the target location, the one or more routes may be exit ramps from a highway, and/or the step of generating the zone may include adjusting a length of the zone based on a pre-calculated electronic table of zone lengths based on observed travel speeds.

According to certain embodiments, systems are disclosed for managing an online distribution of content to mobile device users. One system includes a data storage device storing instructions for managing the online distribution of content to mobile device users, a processor configured to execute the instructions to perform a method. The method may include, receiving, from a content provider, a request to publish content on the electronic device of a user, the content relating to a target location and the request includes at least one threshold travel parameter to the target location. The method also may include identifying a perimeter location on a route. The travel perimeter location may be at the at least one threshold travel parameter. The method also may include generating a zone extending from the perimeter location to the target location. In addition, the method may include receiving an indication that the electronic device has entered the zone, and transmitting content to the electronic device of the user, the content relating to the target location.

According to certain embodiments, a computer-readable medium is disclosed that, when executed by a computer system, causes the computer system to perform a method for managing an online distribution of content to mobile device users, including receiving, from a first content provider, a request to publish content on a user's mobile electronic device relating to a target location. The request may include at least one parameter associated with a threshold distance from the target location The method may include, receiving, from a content provider, a request to publish content on the electronic device of a user, the content relating to a target location and the request includes at least one threshold travel parameter to the target location. The method also may include identifying a perimeter location on a route. The travel perimeter location may be at the at least one threshold travel parameter. The method also may include generating a zone extending from the perimeter location to the target location. In addition, the method may include receiving an indication that the electronic device has entered the zone, and transmitting content to the electronic device of the user, the content relating to the target location.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is an illustration of an electronic map having a circular geo-fence, according to an exemplary embodiment of the present disclosure.

FIG. 2 is an illustration of an electronic map having a targeted geo-fence, according to another exemplary embodiment of the present disclosure.

FIG. 3 is a block diagram of a communications environment and systems configured to define geographical zones and display electronic content to electronic map users.

FIG. 4 is an illustration of a local area electronic map having a circular geo-fence, according to an exemplary embodiment of the present disclosure.

FIG. 5 is an illustration of a local area electronic map having a plurality of targeted geo-fences, according to an exemplary embodiment of the present disclosure.

FIG. 6 is a flow diagram of methods for transmitting electronic content to a user based on defined geographical zones, according to exemplary embodiments of the present disclosure.

FIG. 7 is a flow diagram of methods for transmitting electronic content to a user based on defined geographical zones, according to exemplary embodiments of the present disclosure.

FIG. 8 is a simplified functional block diagram of a computer system configured as a server, for example, to function as a geographic zone and content server, according to exemplary embodiments of the present disclosure.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

The present disclosure describes methods and systems for detecting the location of an electronic device to determine the geographic location of a user, and presenting the user with electronic content based on the determined location. Specifically, the present disclosure describes methods and systems for presenting electronic content to a user based on the user's geographic location relative to a predefined geographic zone, such as a geo-fence, associated with a geographic location, business, POI, or any other location. In some embodiments, methods and systems are disclosed for presenting electronic content to a user based on the user's geographic location (detected via the user's device location) relative to a road location, such as a highway exit or road intersection. For purposes of illustration, if a user's device is detected within a geo-fence extending over the road lanes approaching a highway off-ramp, then the user may be presented with electronic content and/or ads related to locations or businesses associated with the highway off-ramp (e.g., on the intersecting road or in the city or town of the exit). In still further embodiments, methods and systems are disclosed for presenting electronic content to a user also based on the user's ability to travel to a particular physical location related to the electronic content within some predetermined travel time and/or distance. For purposes of illustration, if a user's device is detected within a geo-fence extending over all of the road lanes from which the user can reach the target location within some predetermined travel time or distance, then the user may be presented with electronic content related to the target location.

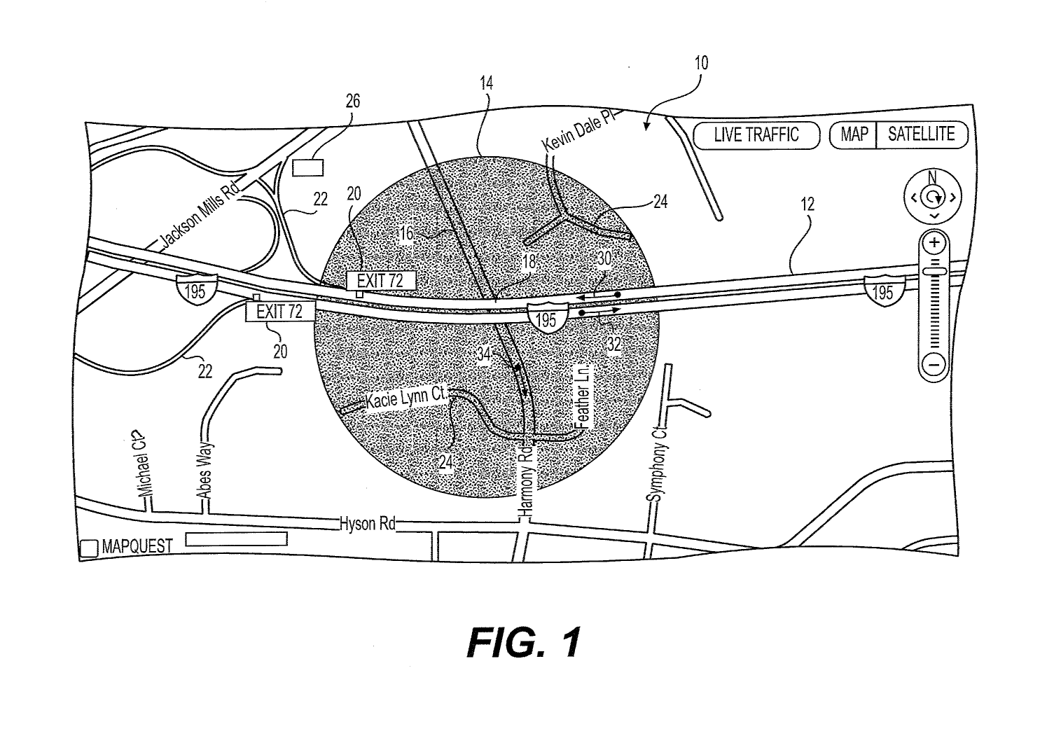

FIG. 1 is an illustration of an electronic map 10 including a generally circular geo-fence 14 in the vicinity of an exemplary target location 26. As used herein, the term “geo-fence” or “geofence” generally refers to a virtual geographic zone having a perimeter and an area within the perimeter. The geo-fence may or may not be visible to a user viewing an electronic map, but for illustrative purposes, FIG. 1 depicts a geo-fence 14 superimposed over the electronic map 10. The target location 26 may be defined by any type or combination of GPS coordinates, address, road intersection, building, business, POI, venue, public space, or any other location of interest. The geo-fence 14 may have any predefined radius and may be positioned at, or at any suitable distance from, the target location 26. In one embodiment, the geo-fence 14 may be centered around the target location 26. In another embodiment, the geo-fence 14 may be centered at an intersection selected near the target location 26. In yet another embodiment, the geo-fence 14 may be centered at any other point or related point within some predetermined distance from the target location 26. As will be discussed in detail below, the geo-fence may be generated according to parameters provided by one or more electronic content providers and used to target users within the area defined by the geo-fence with relevant electronic content. In one embodiment, the geo-fence may be generated according to instructions received from an owner, operator, or other affiliate of the target location 26. Alternatively or additionally, the geo-fence may be generated according to parameters defined by an advertising network, mapping service, and/or geo-fencing service provider. The geo-fence 14 may include all of the area within a radius of the geo-fence, including one or more portions of various routes on the electronic map 10, such as highways 12 having one or more exits 20 and exit ramps 22, roads 16, such as local roads 24, as well as intersections 18.

In one embodiment, the geometry or properties (e.g., radius and location) of the geo-fence may be predetermined by the owner, operator, or other affiliate of the target location 26. The geo-fence 14 may be used by the owner, operator, or other affiliate of one or more locations, such as target location 26, to present users within the geo-fence 14 with electronic content related to the target location. For example, an owner of a restaurant at location 26 may use geo-fence 14 to identify users within a certain radius or threshold distance (e.g., a geodesic distance) from the restaurant and send electronic content to users travelling within the geo-fence 14 via one or more servers. For purposes of illustration, the restaurant owner or operator may transmit electronic coupons and/or advertisements to users traveling within the restaurant's geo-fence, to entice those nearby users to visit the restaurant. As shown in FIG. 1, geo-fence 14 may include, and cause the transmission of relevant content to, any user traveling within the perimeter of the geo-fence 14, for example, a user 30 who is travelling on highway 12 in a direction toward location 26, a user 32 travelling on the highway 12 in a direction away from target location 26, and a user 34 travelling on a road 16 by which the target location 26 is not directly connected or accessible, regardless of actual or estimated travel time.

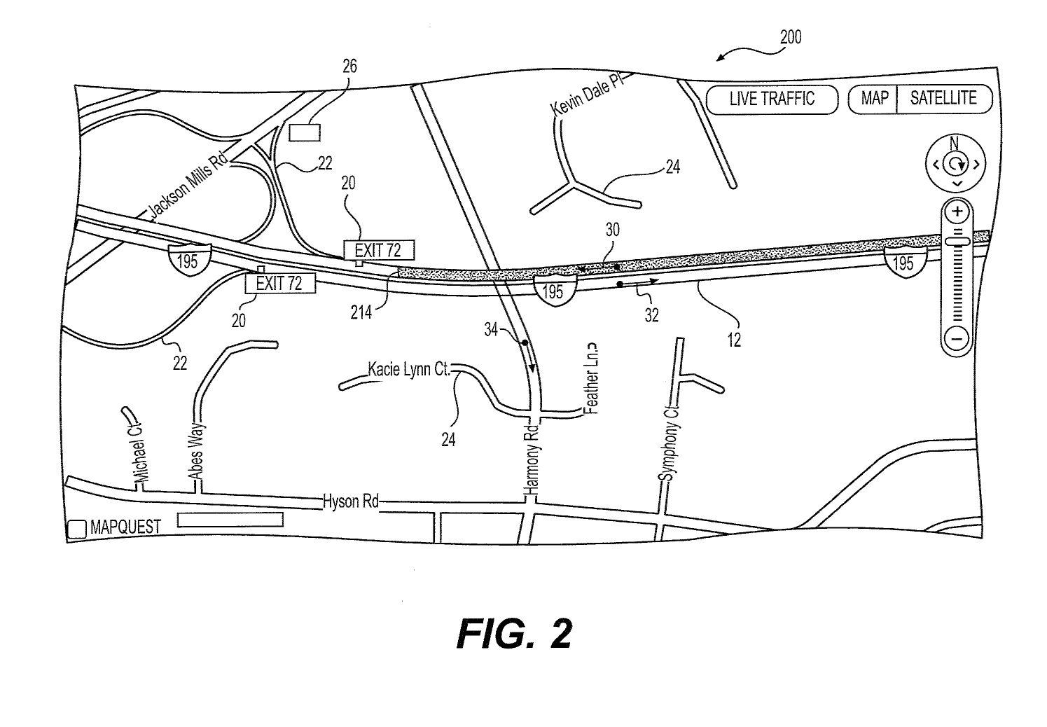

FIG. 2 is an illustration of an electronic map 200 similar in many respects to the electronic map 10 in FIG. 1; however, as shown in FIG. 2, the geo-fence 214 may be similar in dimensions to a portion of a route, such as one or more lanes of highway 12. For purposes of illustration, in one embodiment, the shape of geo-fence 214 may be defined by (i) a width of one or more road lanes approaching a highway exit or road intersection, and (ii) a length of the road lanes extending from a point near the highway exit or road intersection to a point at a predetermined distance or travel time upstream along the road. Thus, consistent with embodiments the present disclosure, one or more businesses, or target locations associated with the highway exit or road intersection may target electronic content and/or ads to users as they approach the highway exit or road intersection. According to certain embodiments, the predetermined distance or travel time upstream along the road may be defined such that the user has sufficient time to exit the highway or to make a turn at the road intersection.

According to certain embodiments, as shown in FIG. 2, the geo-fence 214 may in some cases have a substantially polygonal or polygonal shape, such as that of a rectangle. In other embodiments, more than one polygonal shaped geo-fence 214 and/or a network of polygonal or multi-shaped geo-fences may be used. Referring again to FIG. 2, the geo-fence 214 may have a width corresponding to the width of one or more lanes of a route with traffic flow in a direction toward the target location 26 (or a highway exit or road intersection associated with the target location 26), and as such may, e.g., include user 30 who is heading toward exit 20 and therefore possibly toward target location 26. However, geo-fence 214 may advantageously exclude user 32, who is heading away from exit 20 and target location 26, and exclude user 34, who is traveling on a route that is not easily accessible to target location 26. In other words, by having its shape defined by the travel lanes approaching an associated highway exit or road intersection, a targeted geo-fence consistent with the present disclosure may advantageously target users approaching (or at least accessible to) a target location 26, but advantageously exclude users who are either not travelling in a direction toward the target location 26, or who are travelling on a route by which the target location 26 is not directly accessible. As will be described in more detail below, in certain embodiments, the length of the geo-fence 214 may be determined by either a predetermined geodesic distance (e.g., 1 mile, 3 miles, 10 miles, etc.), and/or travel time to the target location 26 (e.g., 3 minutes, 10 minutes, 20 minutes, etc.).

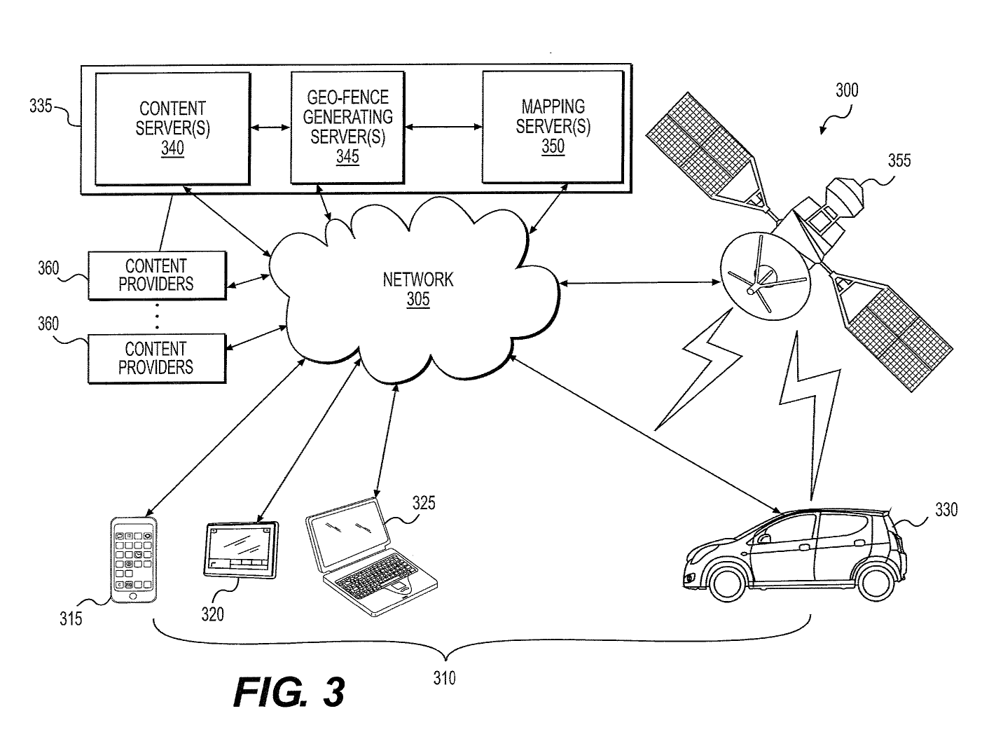

FIG. 3 is an illustration of an exemplary environment 300 in which content may be presented to a user's mobile electronic device 310 having GPS and/or a mapping software application. The mobile electronic device 310 may be any device connected to, or capable of connecting to a network 305, such as the Internet. Examples of such mobile electronic devices 310 may include mobile phones 315, in car or portable GPS devices 320 and 330, computers 325 (e.g., laptops and tablets), smart watches, etc. The mobile electronic devices 310 may send and receive information via the network 305 and/or one or more satellites 355. The mobile electronic devices 310 also may communicate with a system of servers 335 via the network 305. The system of servers 335 may include one or more servers, such as content parameter server(s) 340, geo-fence generating server(s) 345, and/or mapping server(s) 350 in communication with each other. In addition, the system may include one or more content providers 360 in communication with the server system 335. Examples of content providers may include advertisers, news agencies, government agencies, publishers, etc.

The content server 340 may include a database of parameters received from one or more content providers 360 for sending content to users within a geo-fence. Such parameters may include parameters related to the geo-fence, demographic characteristics of users, and/or any other suitable parameters, or combination of parameters. Examples of parameters related to the geo-fence may include a travel distance and/or time from the target location, travel direction, travel speed, type of route (e.g., highway, tollway, road, local road, etc.). Examples of parameters related to the demographic information of a user may include vehicle type, average speed of the user, past online search history, driving habits, etc. Examples of other content parameters the content server 340 may receive from one or more content providers 360 may include weather conditions, date, day, time, etc., any of which may be used to control whether and how to transmit electronic content and/or advertising to user devices identified within one or more geo-fences. For example, for purposes of illustration, in the days or weeks preceding Independence Day, a fireworks store in one state might wish to send an online ad and/or coupon to users travelling on a highway within 10 minutes travel time to the closest highway exit to the fireworks store in a direction towards another state where there is a higher state tax on fireworks. Of course, it should be appreciated that any type of business or entity might target geo-fences to any combination of roads or intersections, at any desired day or time, to target any desired segment of the population, with any relevant electronic content and/or ads. The parameters received by the content server 340 may be processed by the content provider 360 and saved in a database, which may be accessed by the one or more geo-fence generating servers 345.

The geo-fence generating server(s) 345 may generate one or more virtual electronic geo-fences based on the parameters received by the content server 340 and may retrieve relevant mapping information from the mapping server 350 in order to accurately generate the geo-fence in accordance with the parameters received from the content provider 360. According to various embodiments, the geo-fence generating server(s) 345 may generate, maintain, and implement any number of geo-fences, simultaneously, for any number of roads and/or intersections, businesses, promotions, etc. Each geo-fence maintained by the geo-fence generating server(s) 345 may have any desired shape, such as the shape of a portion of one or more highway lanes, the shape of an intersection, the shape of a plurality of road/intersection portions, a polygon (or plurality thereof), a rectangle (or plurality thereof), etc. In one embodiment, the geo-fence generating server(s) 345 may generate the one or more geo-fences based on inputs received from content server(s) 340, mapping server(s) 350, content provider(s) 360, or any other publishers, advertisers, etc. The geo-fence generating server(s) 345 may, in combination with the mapping server(s) 350, monitor the location of one more users' devices relative to perimeter/area information associated with each geo-fence to generate and maintain an updated list of the devices that enter and remain within each geo-fence.

The mapping server 350 may store and process information regarding road geometry, road intersections, routing graphs, traffic patterns, road closures, event information, average traffic speed, etc. In addition, the system may be in communication with the electronic devices 310 via the network 305 and/or satellite(s) 355 to receive location, travel, and any other user information that may be used to generate geo-fences and identify devices within each geo-fence in accordance with the content parameters. For illustrative purposes only, the server system 335 is shown in FIG. 3 to include servers 340, 345, and 350 in a unitary structure, however, it should be understood that any or all of the servers 340, 345, and 350 may be external to each other and owned and/or operated by different entities, as long as electronic communication may occur within one or more of the servers 340, 345, and 350. Any of servers 340, 345, and 350 may operate in conjunction with each other, and/or perform the functions of each other.

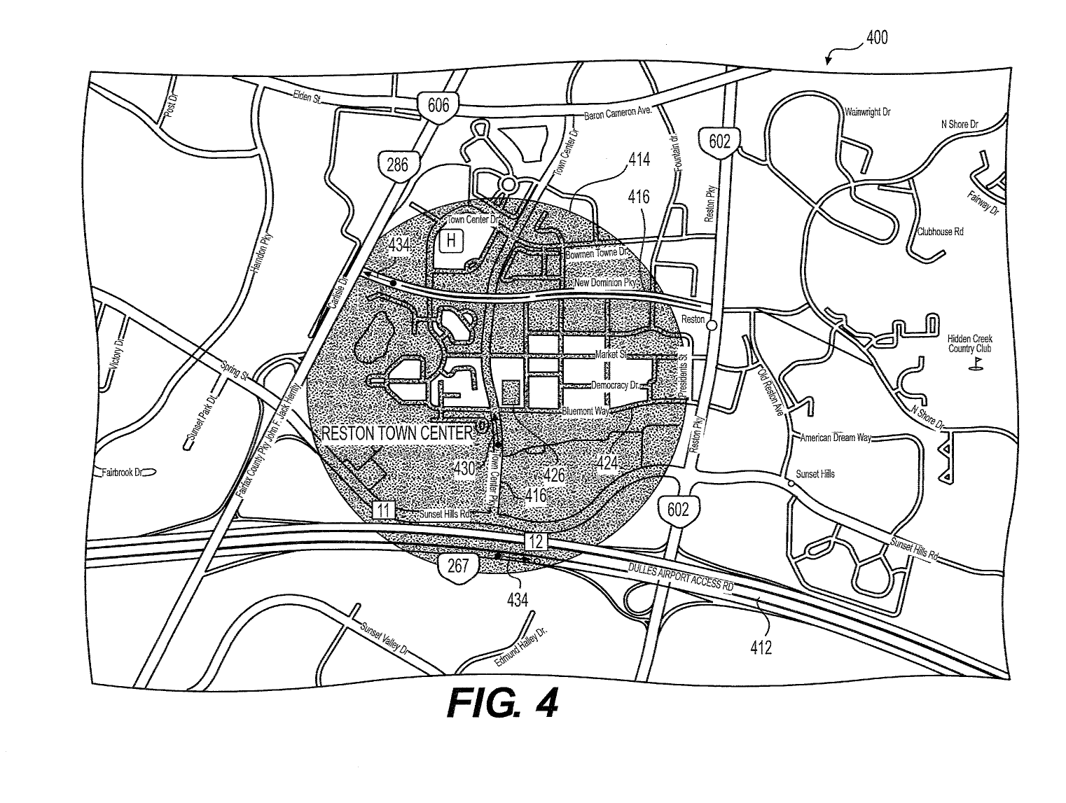

FIG. 4 is an illustration of a local area electronic map 400 similar in some respects to the electronic map 10 in FIG. 1; however, the geo-fence 414 shown in FIG. 4 may be around an area different from the highway embodiment of FIGS. 1-2. For example, as shown in FIG. 4, electronic map 400 may include a smaller area, for example, around a downtown area, a town center, campus, neighborhood, or the like. As shown in FIG. 4, the geo-fence 414 may have any suitable predefined radius and may be positioned any suitable distance from a target location 426. As shown in FIG. 4, geo-fence 414 may include any portion of a route that is within the perimeter of the geo-fence, and therefore may include, for example, user 430, who is travelling on a portion of a road 416 in close proximity to the target location 426 as well as a user 434 travelling on a portion of highway 412 within the geo-fence 414 from which the target location 426 may not be directly accessible, or may be outside a desired travel time and/or distance threshold from the target location 426.

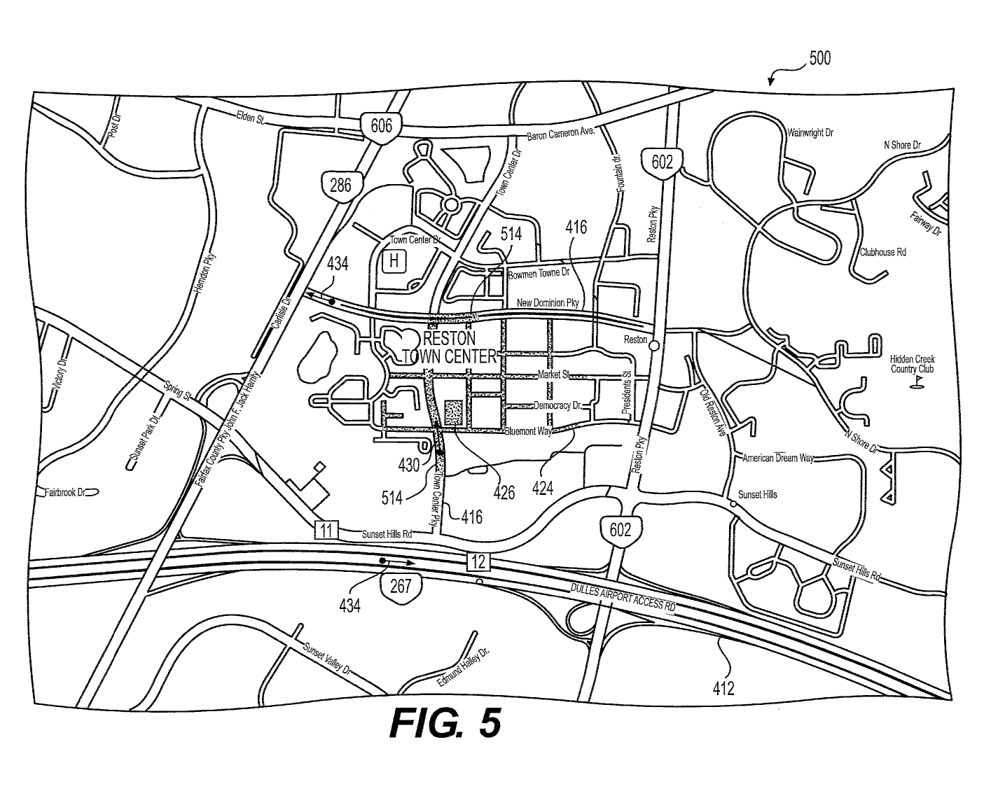

FIG. 5 is an illustration of an electronic map 500 that is similar in most respects to the electronic map 400 in FIG. 4; however, the geo-fence 514 shown in FIG. 5 may include all portions of roads by which the target location 426 may be accessed within a predetermined travel time or travel distance from target location 426. In one embodiment, the geo-fence 514 may include one or more polygonal shapes that may be connected in a grid or network so as to overlay all portions of roads by which the target location 426 may be accessed within a predetermined travel time or travel distance from target location 426. The geo-fence 514 may be generated by determining any point of any road from which a user could travel to the target location 426 by traveling a time or distance less than a predetermined threshold. The road points not satisfying such criteria may be filtered out, and the road points satisfying such criteria may be used to generate the grid or network of the geo-fence 514 overlaying the roads relatively near the target location 426.

In one embodiment, the geo-fence 514 may include only those routes having a relatively short travel time and/or travel distance via relatively direct access to a route by which the target location 426 may be accessed. For purposes of illustration, a business might provide requests or instructions for server systems 335 to deliver related electronic content to users within 100 yards, 500 yards, 1 mile, 3 miles, 5 miles, 10 miles, 20 miles, or 50 miles of the business, and/or within 1 minute, 5 minutes, 10 minutes, or 1 hour of the business. Of course, the business and/or operators of server systems 335 may generate more complicated timing/distance rules for delivery of electronic content (e.g., target user devices within the one of: 1 mile or 10 minutes; or target user devices within 5 miles, but no longer than 10 minutes' drive, etc.). In one embodiment, the routes may be evaluated based on a real-time travel time and/or distance from the target location, taking into account current traffic, road closures, etc. For example, as shown in FIG. 5, a user 434 travelling on highway 412 may be a short geodesic distance (e.g., as the crow files) from the target location. However, the amount of actual travel (e.g., driving, biking, walking) time to the target location 426 may be significantly higher than that associated with the geodesic distance, and especially higher compared to that of user 430, who may be on a road 416 within a short travel time from target location 426. Accordingly, the generation of targeted geo-fences consistent with the above description and with FIG. 5 may advantageously enable delivery of content to users who are within an actual travel time or distance from the target location 426, enabling the delivery of advertising, promotions, and other electronic content that can motivate the attendance of people most likely or able to visit the target location 426.

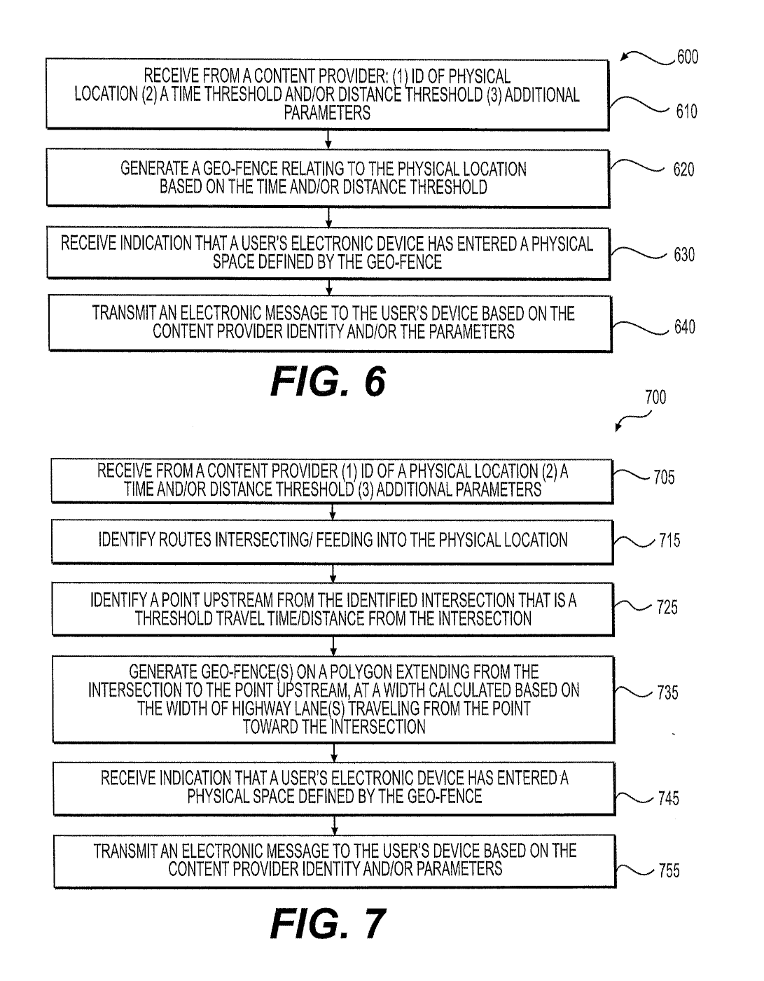

FIG. 6 is a flow diagram of a method 600 for presenting online content to a user. The method 600 may include a step 610 of receiving, from a content provider 360, an identification of one or more parameters for displaying electronic content and/or advertisements to users. The content provider 360 may be an advertiser or other content publisher as discussed above. The parameters may be any suitable parameters such as, e.g., an identification of a physical location, a time threshold, and/or distance threshold, and any other additional parameters, such as user demographics, time-of-day parameters, promotions, etc. The location parameters may include a physical location (e.g., street address, highway exit, map coordinates, etc.) and a predefined threshold distance, and/or travel time to the physical location. The physical location may be the physical location of an entity or business related to the electronic content and/or advertising or another location close to the entity relation to the online content (e.g., the closest highway exit to the entity, or the closest major intersection to the entity, etc.)

The threshold parameter may be any suitable value, e.g., about 1 to 5 miles, about 3 to 10 minutes travel time (by driving, walking, etc.) The user demographic information may include the type of vehicle, age, gender, interests, income, category, number of travelers with the user, etc. For example, a restaurant may wish to advertise its lunch buffet to users within 3 miles of the restaurant's physical address or 3 miles from the closest highway exit to the restaurant, and may wish to target advertisements to users driving in large capacity vehicles (e.g., buses, vans, etc.,) and therefore provide these parameters to the content server(s) 340.

A geo-fence may be generated at step 620 by a geo-fence generating server 345 or any other suitable entity. The dimensions and properties (e.g., shape, geometry, number) of the geo-fence may be based on the parameters electronically received at step 610. For example, as described above with respect to FIG. 2, the geo-fence may be generated for a particular highway exit or road intersection, and may extend in a direction opposite the flow of traffic by a distance sufficient to give users sufficient time to make a decision to, and then proceed to, make a turn or other maneuver at the highway exit or road intersection. Alternatively, as described above with respect to FIG. 5, the geo-fence may be generated so as to cover all of the road portions within some predetermined travel time and/or travel distance from a particular target location or entity.

At step 630, one or more of the servers 335 may generate or receive an indication that a user's electronic device has entered a physical space defined by the geo-fence. For example, the geo-fence generating server 345 and/or mapping server(s) 350 may determine the location of a user's mobile electronic device 310, via the network 105 and/or satellite(s) 355, relative to a stored perimeter and/or area associated with each of a plurality of known geo-fences. The user's electronic device 110 may be detected by accessing GPS data or any other suitable method (e.g., Wi-Fi triangulation, etc.) of detecting the location of the electronic device 110 within the geo-fence parameters. The indication may be an electronic request sent by the geo-fence generating server 345 to the content server via the network. The indication may include any additional information about the user received via the user's electronic device 110, such as previous map searches, etc.

At step 640, the content server 340 may send electronic content and/or advertisements provided by the content provider 360 via the network 305 to the user's electronic device 110 based on the parameters identified by the content provider 360 at step 610. As described above, the electronic content and/or advertisements may include, by way of example, electronic coupons, electronic promotions, recommendations, product/service rankings, sponsored content, opinion content, advertisements, any of which may be embodied in any type or combination of text, graphics, animation, video, one- or two-dimensional barcodes, unique identifiers, electronic messages (e-mail, SMS, etc.), mobile application notification, etc. As described above, the electronic content and/or advertising may be related to the products, services, or other business of the owner, operator, or affiliate of the target location associated with the respective geo-fence. For example, when a user's device enters the physical space defined by a geo-fence requested or sponsored by a department store, the user may be presented with an advertisement or promotion for the user to purchase goods from the department store. When a user's device enters a portion of a highway or road (preceding an exit or intersection) covered by a geo-fence requested or sponsored by a gas station, restaurant, or hotel, the user may be presented with an advertisement or promotion for the user to purchase goods or services associated with the gas station, restaurant, or hotel, respectively.

FIG. 7 shows a flow diagram 700 of another method for presenting online content to a user that is similar in some respects to the method 600 shown in FIG. 6. However, in method 700, electronic content may be targeted to users travelling toward, or predicted to travel toward, a target location. The method 700 may include a step 705 of receiving, from content provider 360, an identification of a physical location, time and/or distance threshold, and any additional parameter for sending electronic content to users. At step 715, a mapping server may identify one or more roads intersecting a route where the physical location is located, such as highway lanes with off-ramps leading to the physical location identified at step 705. Alternatively, one or more servers of server systems 335 may receive a desired intersection or exit identity from an owner, operator, or affiliate of the target location.

At step 725, the mapping server may identify, based on one or more parameters specified by an owner, operator, or affiliate of the target location (e.g., a content providers 360 or publisher) a point upstream from the identified intersection that is a threshold travel time and/or distance from the intersection identified at step 715. The user metadata may be generated by querying the mapping server using geographic information system (GIS) methods and passively collected GPS points from navigation applications. Examples of detailed metadata may include direction of travel, average speed by time of day and day of week, average number of travel lanes and secondary intersecting roads (i.e., road taken upon exiting the highway), etc.

The geo-fence generating server 345 may then generate a geo-fence at step 735 based on an area, e.g., a polygon, extending from a point at or near the intersection to the identified point upstream. In one embodiment, the shape, e.g., polygon, may have a width calculated based on the width of one or more highway lanes travelling in the direction from the point toward the intersection. The geo-fence may be generated by starting from a “decision point” (e.g., the latest point a user can reasonably exit the closest highway exit ramp to the physical location, e.g., at or near where it intersects the highway) and extending in the opposite direction of travel (e.g., “upstream”) for a predetermined period, e.g., 3-minute distance). In one embodiment, this distance may be calculated by taking the average highway speed (for that hour of day and that day of the week) divided by 60 minutes, then multiplied by the number of minutes, in this case, 3. For example, a highway with average speed of 60 mph would result in a length of about 3 miles, based on (60/60)*3=3. Alternately, a highway with average speed of 70 mph would result in a length of about 3.5 miles, based on (70/60)*3=3.5. Any of these lengths may then represent the length of a desired geo-fence. This width of the length may then be expanded into a geo-fence roughly represented by a rectangular polygon, based on the width of one or more lanes of the highway. In one embodiment, the width may be calculated by multiplying the number of lanes by a predetermined width (e.g., 12 feet, or any other minimum lane width of US highways). As described above, the resulting polygon may provide for highly relevant, highly targeted advertising with sufficient decision time for users.

For each highway exit, an electronic table of geo-fence lengths may be pre-calculated based on hour of day and day of week (whereas geo-fence widths may be unaffected by average travel speed). The electronic table may be stored in a database of a server, such as the mapping server 350 and/or geo-fence generating server(s) 345 and can be accessible to any of the other servers 335. The electronic table may be updated based on various conditions, (e.g., weather, date, time, event, etc.). For example, a 3-minute geo-fence may be longest when the average travel speed is highest (e.g., early Sunday mornings) and shortest when the average travel speeds is lowest (e.g., Friday at rush hour).

At step 745, an indication that a user's electronic device 110 has entered a physical space defined by the geo-fence may be received by a server, such as the geo-fence generating server 345 and/or mapping server(s) 350, via the network 105 and/or satellite(s) 355. The user's electronic device 110 may be detected based on obtaining GPS data or any other suitable method of detecting the location of the electronic device 110 within the geo-fence parameters. The indication may be an electronic request sent by the geo-fence generating server 345 to the content server 340 via the network 305. The indication may include any additional information about the user received via the user's electronic device 110, such as previous map searches, etc.

At step 755, the content server 340 may send content provided by the content provider 360 via the network 305 to the user's electronic device 110 based on the parameters identified by the content provider at step 610. As described above, the electronic content and/or advertisements may include, by way of example, electronic coupons, electronic promotions, recommendations, product/service rankings, sponsored content, opinion content, advertisements, any of which may be embodied in any type or combination of text, graphics, animation, video, one- or two-dimensional barcodes, unique identifiers, electronic messages (e-mail, SMS, etc.), mobile application notification, etc. As described above, the electronic content and/or advertising may be related to the products, services, or other business of the owner, operator, or affiliate of the target location associated with the respective geo-fence.

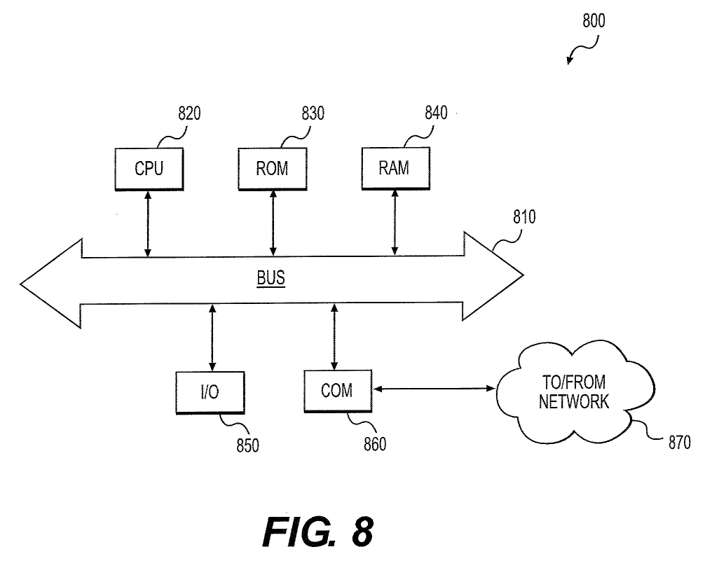

FIG. 8 provides a functional block diagram illustration of computer hardware platforms consistent with any of the devices and servers described herein. FIG. 8 illustrates a network or host computer platform 800, as may typically be used to implement a server. It is believed that those skilled in the art are familiar with the structure, programming, and general operation of such computer equipment and as a result, the drawings should be self-explanatory.

A platform for a server or the like 800, for example, may include a data communication interface for packet data communication 860. The platform may also include a central processing unit (CPU) 820, in the form of one or more processors, for executing program instructions. The platform typically includes an internal communication bus 810, program storage, and data storage for various data files to be processed and/or communicated by the platform such as ROM 830 and RAM 840, although the server 800 often receives programming and data via network communications 870. The hardware elements, operating systems, and programming languages of such equipment are conventional in nature, and it is presumed that those skilled in the art are adequately familiar therewith. The server 800 also may include input and output ports 850 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A computer-implemented method for executing an online distribution of content to user devices, the method including:
receiving, from a content provider, a request to publish content on an electronic device of a user, wherein the content relates to a target location, and the request includes at least one threshold travel parameter to the target location;
identifying a perimeter location on a route, wherein the perimeter location is at the at least one threshold travel parameter;
generating a zone extending from the perimeter location to the target location;
receiving an indication that the electronic device of the user has entered the zone; and
transmitting content to the electronic device of user, the content relating to the target location.

2. The method of claim 1, wherein the threshold travel parameter is travel time.

3. The method of claim 2, wherein the travel time is between 2 to 7 minutes.

4. The method of claim 2, wherein the travel time is based on current average traffic speed.

5. The method of claim 1, wherein:
the step of identifying a perimeter location on a route, comprises identifying a plurality of perimeter locations each on a plurality of routes, wherein each of the plurality of perimeter locations is at the at least one threshold travel parameter,
the step of generating a zone comprises generating a plurality of zones extending from each of the plurality of the perimeter locations to the target locations, and
the step of receiving an indication comprises receiving an indication that the electronic device of the user has entered any one of the plurality of zones.

6. The method of claim 5, wherein each of the plurality of zones has a shape corresponding to the shape of one of the plurality of routes.

7. The method of claim 6, wherein each of the plurality of zone has a width corresponding to the width of a lane of one of the plurality of routes in a direction toward the target location.

8. The method of claim 1, wherein the zone has a width corresponding to the width of a lane of the route in a direction toward the target location.

9. The method of claim 1 further comprising receiving other user information.

10. The method of claim 1, wherein the content is an advertisement for the target location.

11. The method of claim 1, wherein the zone exclude routes with traffic travelling in a direction away from the target location.

12. The method of claim 1, wherein the one or more routes are exit ramps from a highway.

13. The method of claim 1, wherein the step of generating the zone comprises adjusting a length of the zone based on a pre-calculated electronic table of zone lengths based on observed travel speeds.

14. A system for managing an online distribution of content to mobile device users, the system including:
a data storage device storing instructions for managing the online distribution of content to mobile device users; and
a processor configured to execute the instructions to perform a method including:
receiving, from a content provider, a request to publish content on an electronic device of a user, wherein the content relates to a target location, and the request includes at least one threshold travel parameter to the target location;
identifying a perimeter location on a route, wherein the perimeter location is at the at least one threshold travel parameter;
generating a zone extending from the perimeter location to the target location;
receiving an indication that the electronic device of the user has entered the zone; and
transmitting content to the electronic device of user, the content relating to the target location.

15. The system of claim 14, wherein the threshold travel parameter is travel time.

16. The system of claim 15, wherein the travel time is between 2 to 7 minutes.

17. The system of claim 15, wherein the travel time is based on current average traffic speed.

18. The system of claim 14, wherein the route is an exit ramp from a highway.

19. The system of claim 14, wherein the step of generating the zone comprises adjusting a length of the zone based on a pre-calculated electronic table of zone lengths based on observed travel speeds.

20. A computer-readable medium that, when executed by a computer system, cause the computer system to perform a method for managing an online distribution of content to mobile device users, the method including:
receiving, from a content provider, a request to publish content on an electronic device of a user, wherein the content relates to a target location, and the request includes at least one threshold travel parameter to the target location;
identifying a perimeter location on a route, wherein the perimeter location is at the at least one threshold travel parameter;
generating a zone extending from the perimeter location to the target location;
receiving an indication that the electronic device of the user has entered the zone; and
transmitting content to the electronic device of user, the content relating to the target location.
